(19) United States
(12) Patent Application Publication
(10) Pub. No.: US 2004/0174010 A1
(43) Pub. Date: Sep. 9, 2004

(54) Business card

(76) Inventor: Robert G. McGuiness, Eureka, CA (US)

Correspondence Address: SHLESINGER, ARKWRIGHT & GARVEY LLP, PATENT, TRADEMARK & COPYRIGHT LAW, 3000 SOUTH EADS STREET, ARLINGTON, VA, 22202, US

(21) Appl. No.: 10/797,120

(22) Filed: Mar. 11, 2004

Related U.S. Application Data
(63) Continuation of application No. 09/629,450, filed on Jul. 31, 2000, now abandoned.
Application No. 09/629,450 is a continuation-in-part of application No. 09/301,447, filed on Apr. 29, 1999, now Pat. No. 6,098,323.
Application No. 09/301,447 is a continuation-in-part of application No. 08/968,667, filed on Nov. 12, 1997, now Pat. No. 5,914,158.

(51) Int. Cl. G09F 1/00

(52) U.S. Cl. 283/56

(57) ABSTRACT

A business card which has the normal information, such as name address and telephone number printed on one side of the card and this same information is printed on a static cling sheet which is attached to the opposite side of the card.

### BACKGROUND OF THE INVENTION

This invention relates, in general, to business cards, and, in particular, to a business card that has the normal information imprinted on a static cling sheet and also on the business card.

### DESCRIPTION OF THE PRIOR ART

In the prior art various types of static cling sheets have been proposed. For example, U.S. Pat. No. 4,652,239 to Brimberg discloses graphic designs representing furniture which are printed on static cling sheets to aid in designing rooms.

U.S. Pat. No. 5,258,214 to Cooledge et al discloses a wall covering having a design printed on a static cling material to provide temporary wall coverings.

U.S. Pat. No. 5,970,638 to Henley discloses a door covering having a design printed on a static cling material to provide decoration to the door.

U.S. Pat. No. 5,893,229 to Werner discloses a device for framing articles such as photographs which has a cover for the photo made from a static cling material.

### SUMMARY OF THE INVENTION

The present invention is directed to a business card which has the normal information, such as name address and telephone number printed on one side of the card and this same information is printed on a static cling sheet which is attached to the opposite side of the card.

It is an object of the present invention to provide a new and improved business card.

It is an object of the present invention to provide a new and improved business card which has the normal information printed on a static cling sheet.

It is an object of the present invention to provide a new and improved business card which has the normal information printed on a static cling sheet which can be detached from the card and secured in a separate location from the card.

These and other objects and advantages of the present invention will be fully apparent from the following description, when taken in connection with the annexed drawings.

### BRIEF DESCRIPTION OF THE DRAWINGS

FIG. 1 is a plan view of one side of the business card of the present invention.

FIG. 2 is a plan view of the opposite side of the business card of the present invention.

### DESCRIPTION OF THE PREFERRED EMBODIMENT

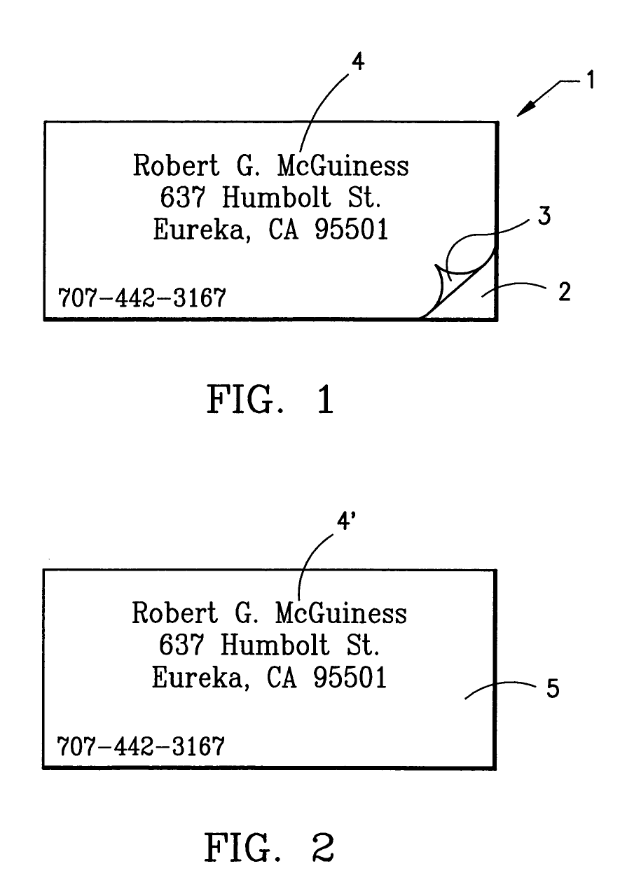

Referring now to the drawings in greater detail, FIG. 1 shows one side of the business card 1 of the present invention. The card has a first side 2 to which a static cling sheet 3 is secured. The static cling sheet is made from plastic, although any material which has static cling properties could be used with out departing from the scope of the present invention. Printed on the static cling sheet 3 is the normal information 4 that can be found on any conventional business card. It should be noted that in FIG. 1, the name address and telephone number are shown, however, this is merely for illustrational purposes. Any information that a user wants to present to prospective clients can be placed on the static cling sheet 3. For example, the user's picture, E-mail address, fax number, cell phone number, company logo, or any other information that the user desires could be placed on the static cling sheet 3 without departing from the scope of the present invention.

In addition, the method by which the information is placed on the static cling sheet 3 is not material. For example, the information could be printed or embossed on the static cling sheet 3, or any other convention method used to place the information on the static cling sheet 3.

FIG. 2 shows the reverse, or other side 5, of the business card 1 of the present invention. As can be seen, the same information that is on the static cling sheet 3, is also presented on the side 5 of the business card. This information can be placed on the side 5 in the same manner as the information is presented on the static cling sheet 3. In the alternative, the information can be placed on the side 5 in a different manner than it is on the static cling sheet 3. For example, the information can be printed on the static cling sheet 3 and embossed on the side 5 of the business card.

A user of this new type of business card 1 will use it in much the same way as he/she would use any standard business card. However, when the recipient of the card receives it he/she has an option not available with the standard business card. The recipient of the new business card 1 can easily separate the vinyl portion 3 of the card from the standard portion of the card 2. The standard portion of the card, with the side 5 exposed can be filed in the usual manner. For example the card could be placed in file, stapled to other papers, scanned into a computer, or placed in a business card wallet, for example.

However, the vinyl portion 3 of the card can be placed wherever it is convenient to the recipient. For example, the recipient could place the vinyl portion of the card on his/her computer monitor as a reminder to contact the person named on the card. In the alternative, the recipient could place the vinyl portion 3 of the card on any surface that the vinyl portion 3 will cling to.

In this manner, the new type of business card 1 will be more versatile than the standard business card, since it can be separated and placed in two different locations or where ever it is convenient to the recipient

Although the Business Card and the method of using the same according to the present invention has been described in the foregoing specification with considerable details, it is to be understood that modifications may be made to the invention which do not exceed the scope of the appended claims and modified forms of the present invention done by others skilled in the art to which the invention pertains will be considered infringements of this invention when those modified forms fall within the claimed scope of this invention.

What I claim as my invention is:

1. A business card comprising:
a relatively planar sheet of material having a first side and a second side,
said second side having information placed thereon,
said first side having a static cling sheet attached thereto,
said static cling sheet having the same information, placed thereon, as the information on said second side.

2. The business card as claimed in claim 1, wherein said information on said second side, and said information on said static cling sheet comprises:
a name, address and telephone number.

3. The business card as claimed in claim 1, wherein said information on said second side is printed thereon.

4. The business card as claimed in claim 1, wherein said information on said static cling sheet is printed thereon.

5. The business card as claimed in claim 1, wherein said information on said second side is embossed thereon.
